(19) United States
(12) Patent Application Publication
(10) Pub. No.: US 2012/0058805 A1
(43) Pub. Date: Mar. 8, 2012

(54) MOBILE DEVICE AND METHOD FOR CUTOFF-BASED POWER CONTROL

(75) Inventor: Cheol Sun YOO, Gyeongsangbuk-do (KR)

(73) Assignee: SAMSUNG ELECTRONICS CO., LTD., Gyeonggi-Do (KR)

(21) Appl. No.: 13/226,684

(22) Filed: Sep. 7, 2011

(30) Foreign Application Priority Data
Sep. 7, 2010 (KR) 10-2010-0087567

(51) Int. Cl. H04W 88/02

(52) U.S. Cl. 455/574

(57) ABSTRACT

A mobile device and its control method allow a system booting in an emergency mode to operate by redefining a reference cutoff voltage when the mobile device enters into the power-off state in a cutoff mode, wherein the mobile device can support an emergency call service through a minimum booting procedure although other non-essential functions have been curtailed.

### CLAIM OF PRIORITY

This application claims the benefit of priority under 35 U.S.C. §119 from Korean Patent Application No. 10-2010-0087567, filed Sep. 7, 2010, the contents of which are hereby incorporated by reference in its entirety.

### BACKGROUND OF THE INVENTION

1. Field of the Invention

The present invention relates in general to a cutoff-based power control in a mobile device. More particularly, the present invention relates to a mobile device and control method for a cutoff voltage, and a cut-off mode in which the mobile device automatically enters into the power-off state due to a shortage of the remaining battery capacity.

2. Description of the Related Art

With modern scientific technologies dramatic advances, a large number of different types of mobile devices have been increasingly popularized in these days. According to increasing convergence in a mobile functionality, recent mobile devices come to have optionally a plurality of useful optional functions and applications in addition their inherent and basic essential functions. For instance, in addition to traditional communication functions such as a voice calling and a short message service, many other various functions are realized to enjoy or use broadcasts, music, game, camera, Internet, dictionary, etc. in a mobile communication device.

Meanwhile, as a clear majority of the population now has such mobile devices in their possession, there will be a percentage of mobile device users who may be exposed to danger, accidents or any other type of emergency, and such mobile device users can facilitate calling for help in remote places. In this case, a user may try to dial an emergency number or use an emergency call service or SOS service of the mobile device. However, if the mobile device is in the power-off state due to battery discharge, etc., there is no way of asking for help in an emergency or dangerous situation by using the mobile device.

Normally the mobile device operates with battery power that is available for a limited time without recharging due to insufficient capacity. The increased functionality equates with more battery power being used. When the remaining capacity of a battery is lowered to a specific threshold level, the battery may stop supplying power so as to protect the mobile device even though the device might be functional for certain functions. A voltage level at this point is referred to as a “cutoff voltage”, and refers a status in which the mobile device automatically enters into the power-off state due to a shortage of the remaining battery capacity is referred to as a cutoff mode. A cutoff mode of the mobile device begins at the cutoff voltage.

If the mobile device is in the power-off state or enters into the power-off state in a cutoff mode, the mobile device may fail to enter the power-on state without some recharging/regenerative power of the battery since a battery voltage is smaller than the cutoff voltage threshold. Therefore, any user who carries such a mobile device may have much difficulty in coping with an emergency situation.

### BRIEF SUMMARY OF THE INVENTION

Accordingly, the present invention allows the mobile device to operate with a redefined cutoff voltage in case where the mobile device enters into the power-off state in a cutoff mode. The redefined cutoff voltage would leave a predetermined amount of power to make an emergency (S.O.S.) type help call.

An exemplary aspect of the present invention is to allow the mobile device to determine whether or not to drive its system on the basis of a redefined cutoff voltage in case where the mobile device enters into the power-off state in a cutoff mode.

Still another exemplary aspect of the present invention is to redefine a reference cutoff voltage at another value in the case where the mobile device enters into the power-off state in a cutoff mode, and then to allow the mobile device to perform a booting procedure with the redefined cutoff voltage in an emergency mode.

Yet another exemplary aspect of the present invention is to realize optimized environments for an emergency call service by allowing a booting procedure in an emergency mode even in a case where the mobile device enters into the power-off state in a cutoff mode.

Still another exemplary aspect of the present invention is to maximize the use of battery by allowing a minimum booting procedure with the redefined cutoff voltage in an emergency mode after the mobile device enters into the power-off state in a cutoff mode.

Even another aspect of the present invention is to improve user's convenience and safety by realizing environments for supporting an emergency call service even though the mobile device enters into the power-off state in a cutoff mode.

According to one exemplary aspect of the present invention, provided is a method for a cutoff-based power control in a mobile device, the method preferably including: detecting a power-off interaction of the mobile device; if the power-off interaction is based on a cutoff mode, redefining a reference cutoff voltage; forcing the mobile device to enter into a power-off state; and controlling a system driving of the mobile device on the basis of the redefined reference cutoff voltage in the power-off state based on the cutoff mode. The redefined reference cutoff voltage should be sufficient to permit the mobile device to make an emergency call in an emergency mode.

According to another exemplary aspect of the present invention, provided is a mobile device comprising: a battery configured to supply power; a memory unit configured to store a reference cutoff voltage used for an entry into a power-off state based on a cutoff mode; and a control unit configured to redefine the reference cutoff voltage when the mobile device enters into the power-off state based on the cutoff mode, and to control a system driving of the mobile device on the basis of the redefined reference cutoff voltage, particularly in an emergency.

In various exemplary aspects of this invention, the mobile device can determine whether to drive a system on the basis of a redefined cutoff voltage even though the mobile device enters into the power-off state in a cutoff mode. Also, when entering into the power-off state at a cutoff voltage due to a battery discharge, the mobile device can redefine a reference cutoff voltage as another value. Furthermore, in response to the available supply of power, the mobile device can determine whether to drive again its system on the basis of the redefined cutoff voltage and also perform a booting procedure with minimal functionality in view of system loads. Therefore, the presently claimed invention can realize optimized environments for an emergency call service when a user is in danger, accident or any other emergency. The presently claimed invention may improve user's convenience and safety and also promote competitiveness of the mobile device.

Other exemplary aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating an exemplary configuration of a mobile device in accordance with an exemplary embodiment of the present invention.

FIG. 2 is a flow diagram illustrating a power-off control process of a mobile device in case a cutoff mode is activated in accordance with an exemplary embodiment of the present invention.

FIG. 3 is a flow diagram illustrating a power-on control process of a mobile device that has entered into the power-off state in a cutoff mode in accordance with another exemplary embodiment of the present invention.

FIG. 4 is a flow diagram illustrating a power-on control process of a mobile device that has entered into the power-off state in a cutoff mode in accordance with still another exemplary embodiment of the present invention.

FIG. 5 is a flow diagram illustrating a battery recharge control process of a mobile device that has entered into the power-off state in a cutoff mode in accordance with yet another exemplary embodiment of the present invention.

### DETAILED DESCRIPTION

Exemplary, non-limiting embodiments of the present invention will now be described more fully with reference to the accompanying drawings. The claimed invention may, however, be embodied in many different forms and should not be construed as limited to the exemplary embodiments set forth herein. Rather, the disclosed exemplary embodiments are provided so that this disclosure will be thorough to enable the present invention to be practiced without undue experimentation by a person skilled in the art. The principles and features of this invention may be employed in varied and numerous embodiments without departing from the spirit of the invention as embodied in the scope of the appended claims.

Furthermore, some well-known or widely used techniques, elements, structures, and processes may not be described or illustrated in detail to avoid obscuring the essence of the present invention to a person of ordinary skill. Although the drawings represent exemplary embodiments of the invention, the drawings are not necessarily to scale and certain features may be exaggerated or omitted in order to better illustrate and explain the present invention.

The present invention provides cutoff-based power control techniques that allow a mobile device to perform a system booting even though the mobile device enters into the power-off state at a prescribed cutoff voltage due to battery discharge. Specifically, the mobile device of the present invention may redefine a reference cutoff voltage as other value when entering into the power-off state in a cutoff mode using a cutoff voltage, and then may determine whether to drive again its system on the basis of the redefined cutoff voltage. When driving the system according to the redefined cutoff voltage, the mobile device of the present invention may perform a booting procedure with minimum functions in consideration of system loads. Redefining the reference cutoff voltage may prevent a system of the mobile device from stopping due to the former cutoff voltage when the system is driven. Therefore, even though the mobile device enters into the power-off state at the cutoff voltage, a system driving is allowed with the redefined cutoff voltage. Additionally, any user who carries such a mobile device may try to dial an emergency number or use an emergency call service or SOS service.

Now, a mobile device and control methods according to exemplary embodiments of this invention will be described hereinafter. The following embodiments are, however, exemplary only and not to be considered as a limitation of the presently claimed invention. As will be understood by those skilled in the art, any other alternative embodiments may be favorably used.

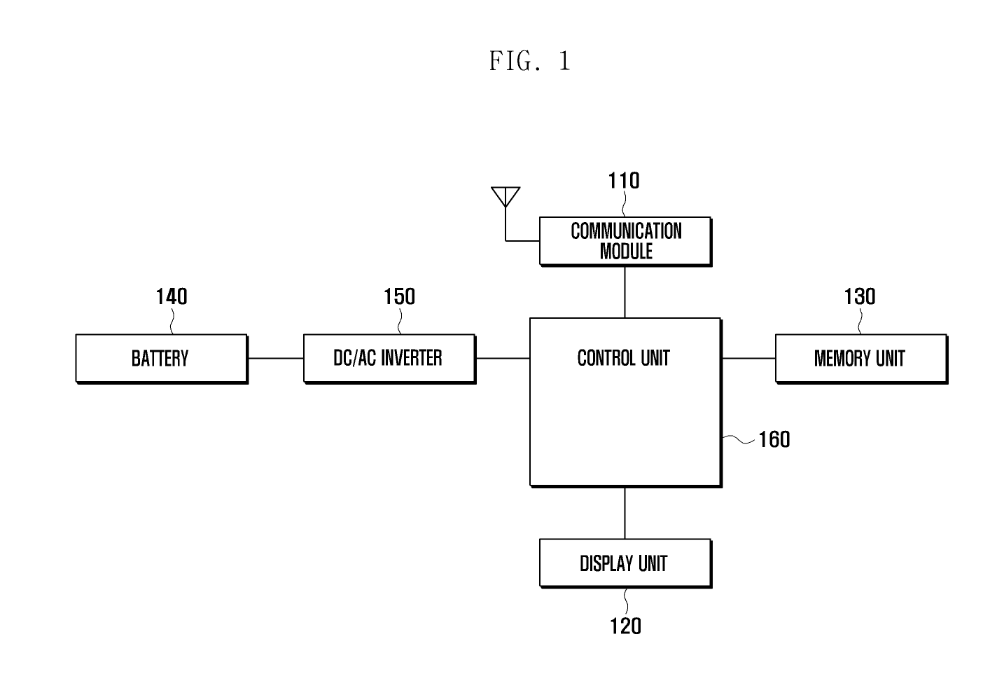

FIG. 1 is a block diagram illustrating the configuration of a mobile device in accordance with an exemplary embodiment of the present invention.

Referring now to FIG. 1, the mobile device preferably includes a communication module 110, a display unit 120, a memory unit 130, a battery 140, a DC/AC inverter 150, and a control unit 160. Additionally, although not illustrated, the mobile device may further include any other typically elements used in portable mobile terminals such as an audio processing unit having a microphone and a speaker, a digital broadcast module for receiving and playing digital broadcasting such as DMB (digital multimedia broadcasting) or DVB (digital video broadcasting), a camera module for taking a photo or recording a video, a Bluetooth communication module for performing a Bluetooth communication function, a touch pad for a touch-based input, a key input unit for a mechanical key input, and the like.

The communication module 110 preferably supports a mobile communication service based on a mobile communication network and/or an Internet service (e.g., Wi-Fi service) based on WLAN (wireless local area network). Particularly, the communication module 110 transmits and receives data (e.g., voice data, message data, etc.) in an emergency call service under the control of the control unit 160. The communication module 110 may comprise a radio frequency (RF) module for performing a mobile communication transceiver function or a WLAN module for performing a WLAN-based Internet communication function. Even though depicted as a single block in FIG. 1, the communication module 110 may be alternatively composed of both modules. Besides, the mobile device may support both services through the RF module only.

The display unit 120 offers execution screens of particular applications supported by the mobile device. For instance, the display unit 120 may offer a great variety of execution screens in connection with a message function, an email function, an Internet function, a multimedia function, a search function, a communication function, an electronic book function, a camera/camcorder function, a broadcasting playback function, a music play function, a widget function, a memo function, a game function, an emergency function, etc. The display unit 120 may be formed of LCD (liquid crystal display), OLED (organic light emitting diode), AMOLED (active matrix OLED), or any other type of thin-film screen. The display unit 120 may offer a landscape mode (i.e., widthwise mode) or a portrait mode (i.e., a lengthwise mode) so as to display such execution screens, depending on a rotated or placed direction of the mobile device. Additionally, the display unit 120 may have a specific interface adapted to support a touch-based input. Namely, the display unit 120 with a touch screen configuration may support a user interaction input based on a touch gesture, create an input signal corresponding to the user interaction input, and send the input signal to the control unit 160.

The memory unit 130 stores a variety of programs and data executed and processed in the mobile device and may be formed of at least one of a non-volatile memory and a volatile memory. Specifically, the memory unit 130 is a non-transitory machine readable medium that may be used to permanently or temporarily store an operating system of the mobile device, programs and data related to a display control of the display unit 120, programs and data related to an input control of the display unit 120, programs and data related to a time check function when the mobile device enters into the power-off state in a cutoff mode, programs and data related to a function to redefine a reference cutoff voltage when the mobile device enters into the power-off state in a cutoff mode, programs and data related to a system booting control of the mobile device that is in the power-off state in a cutoff mode, programs and data related to a recharge control of the battery 140 after the mobile device enters into the power-off state in a cutoff mode, and the like.

Particularly, the memory unit 130 may store various setting information in connection with the operation of an emergency mode in which the mobile device operates on the basis of the redefined reference cutoff voltage after entering into the power-off state in a cutoff mode.

For instance, the memory unit 130 may store a plurality of cutoff voltage values (hereinafter, referred to as the first cutoff voltage, the second cutoff voltage, etc.) for capacity levels of the battery 140. Hereinafter, for purposes of explanation, the first cutoff voltage refers to a normal cutoff voltage used for forcing the mobile device to enter into the power-off state in a cutoff mode, and the second cutoff voltage refers to a cutoff voltage redefined as a reference cutoff voltage when the mobile device enters into the power-off state in a cutoff mode by means of the first cutoff voltage. The second cutoff voltage is smaller than the first cutoff voltage and may be optimized for the operation of the mobile device through experiments. For instance, when the remaining capacity of the battery 140 becomes reduce to a value of voltage less the first cutoff voltage and thereby the mobile device enters into the power-off state in a cutoff mode, the second cutoff voltage may be defined as a specific voltage value that permits a system to be driven with minimum booting scenario.

The battery 140 supplies electric power to the respective elements of the mobile device. Although not shown, the battery could be rechargeable by more than one type of recharging, including, for example, solar.

The DC/AC inverter 150 is disposed between the battery 140 and the control unit 160. The DC/AC inverter 150 receives, converts direct current (DC) into alternating current (AC), DC from the battery 140 and offers AC to the control unit 160. Depending on the type of the battery 140 and the mobile device, the DC/AC inverter 150 may be not included. It is even within the spirit and scope of the invention to including a means for receiving power from an auxiliary battery sufficient to provide emergency service functions.

The control unit 160 controls general operations of the mobile device. Particularly, the control unit 160 may perform cutoff-based power control functions. For instance, the control unit 160 may perform a power-off control process in a cutoff mode when the voltage of the battery 140 is less than a prescribed value (e.g., the first cutoff voltage). Additionally, when performing the power-off control process in a cutoff mode, the control unit 160 may redefine a reference cutoff voltage by changing the reference cutoff voltage from the first cutoff voltage to the second (or possibly third or next) cutoff voltage. Thereafter, to perform a power-on process, the control unit 160 may check whether or not an entry into the power-off state is based on a cutoff mode. If so, the control unit 160 may determine whether to drive a system of the mobile device on the basis of the second cutoff voltage.

If it is determined that a system driving is based on the second cutoff voltage, the control unit 160 may control a system booting procedure based on operating in an emergency mode or in a normal mode. For instance, the control unit 160 may block the supply of power to some of the aforesaid elements and disallow the loading of some functions (e.g., a phonebook loading) other than essential functions required for an emergency call service. Also, the control unit 160 may revoke an emergency mode based on the second cutoff voltage when the battery 140 is changed. And also, while the system is running on the basis of the second cutoff voltage or when a battery recharge is performed in the power-off state, the control unit 160 may revoke an emergency mode based on the second cutoff voltage. The revocation of an emergency mode is temporary to restore setting information changed in the emergency mode, for example, to redefine a reference cutoff voltage as the first cutoff voltage and to stop the operation of RTC timer.

Detailed control processes of the control unit 160 will be described later. Additionally, the control unit 160 performs a variety of control operations in connection with normal functions of the mobile device. For instance, the control unit 160 may control the operation and data display of a selected application being executed. Also, the control unit 160 may receive input signals corresponding to various input types supported by a touch-based input interface and then control the operation of a particular function according to the received input signals. The control unit 160 may control the operation of a function to support an emergency call service based on an emergency mode or a normal mode.

Meanwhile, the mobile device shown in FIG. 1 may be applied to any type such as a bar type, a folder type, a slide type, a swing type, or a flip type of well-known mobile devices. Additionally, the mobile device of this invention may include communication devices, multimedia players and their application equipment. For instance, the mobile device may include many types of mobile communication terminals based on various communication protocols, a tablet PC, a smart phone, a PMP (portable multimedia player), a digital broadcasting player, a PDA (personal digital assistant), a music player (e.g., an MP3 player), a portable game console, a notebook, a net-book, and the like. Also, a cutoff-based power control method of this invention may be applied to the various devices mentioned above as well as other device that could be used to convey emergency information.

As discussed hereinbefore, in an exemplary embodiment of this invention, the memory unit 130 may store the first cutoff voltage initially defined as a reference cutoff voltage and the second cutoff voltage temporarily redefined as a reference cutoff voltage when the mobile device enters into the power-off state in a cutoff mode. Additionally, for a system driving, the mobile device may determine whether an entry into the power-off state is caused by a user's request or by discharge of the battery 140 in a cutoff mode. In case of power-off in a cutoff mode, the control unit 160 may determine whether to drive the system of the mobile device according to the second cutoff voltage. As discussed above, a cutoff mode refers to a status in which the mobile device automatically enters into the power-off state due to a shortage of the remaining battery capacity. Also, a cutoff voltage refers to a specific voltage at which a cutoff mode begins. According to the present invention, the mobile device may perform a system driving in an emergency mode on the basis of the second cutoff voltage redefined as a reference cutoff voltage when the mobile device is in the power-off state due to a cutoff mode, thus supporting an emergency call service.

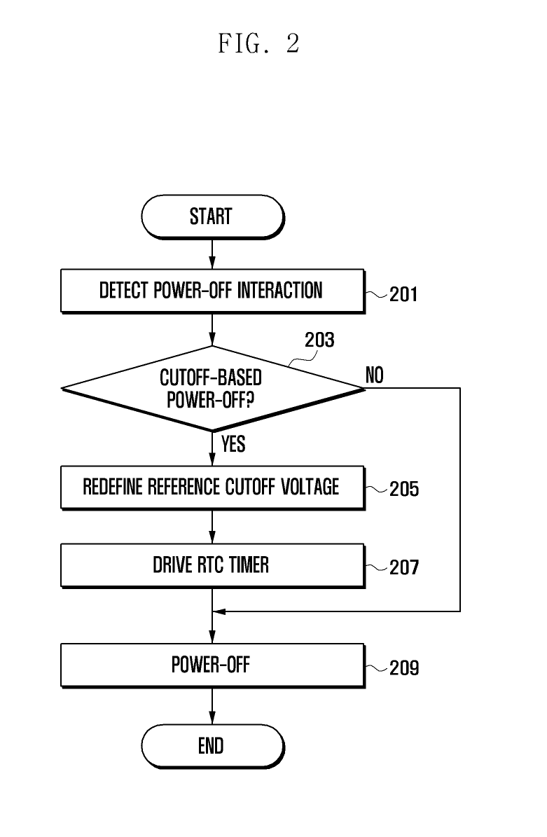

FIG. 2 is a flow diagram illustrating a power-off control process of a mobile device in case of a cutoff mode in accordance with an exemplary embodiment of the present invention.

Referring now to FIG. 2, at step 201 the control unit 160 detects a power-off interaction of the mobile device. A battery discharge below a predetermined threshold or a user's request (actuating a power off switch or touch command, for example) may cause such a power-off interaction.

Next, at step (203) the control unit 160 determines whether or not the power-off interaction is based on a cutoff mode. Specifically, the control unit 160 may determine whether or not the power-off interaction is caused by a cutoff mode due to a reduced battery voltage under a reference cutoff voltage (e.g., the first cutoff voltage) or is forced at a user's request. Hereinafter, the former interaction will be referred to as the first type of interaction and the latter interaction will be referred to as the second type of interaction.

If the power-off interaction is not based on a cutoff mode, namely if the power-off interaction is the second interaction, then at step (209) the control unit 160 forces the mobile device to enter into the power-off state according to a normal procedure.

However, if the power-off interaction at step 201 is the first type of interaction, the control unit 160 changes a reference cutoff voltage (step 205). As discussed above, the memory unit 130 may store the first and second cutoff voltages, and the first cutoff voltage is a reference cutoff voltage in a cutoff mode. Also, the second cutoff voltage is set to be smaller than the first cutoff voltage. Therefore, for a power-off control in a cutoff mode, the control unit 160 redefines a reference cutoff voltage by changing it from the first cutoff voltage to the second cutoff voltage.

Next, (at step 207) the control unit 160 drives an RTC (real time clock) timer when changing a reference cutoff voltage. Namely, the control unit 160 starts a time check by driving the RTC timer. This time check is carried out for a further power-on process in an emergency mode. If any power-on interaction is inputted within a prescribed time after an entry into the power-off state in a cutoff mode, the control unit 160 may drive the system based on an emergency mode. However, if any power-on interaction is inputted after a prescribed time, the control unit 160 may restrict a system driving. A prescribed time may be defined as a time when the remaining capacity of the battery 140 is lowered to the second cutoff voltage. Therefore, the step 207 of driving the RTC timer may be omitted in another exemplary embodiment making a comparison between a current battery voltage and the second cutoff voltage in a power-on process.

After driving the RTC timer, (at step 209) the control unit 160 forces the mobile device to enter into the power-off state. Also, the control unit 160 continues to carry out a time check through the RTC timer. Meanwhile, if the step 207 is omitted, the control unit 160 may perform a power-off process just after changing a reference cutoff voltage.

Now, a power-on process of the mobile device in a cutoff mode will be described.

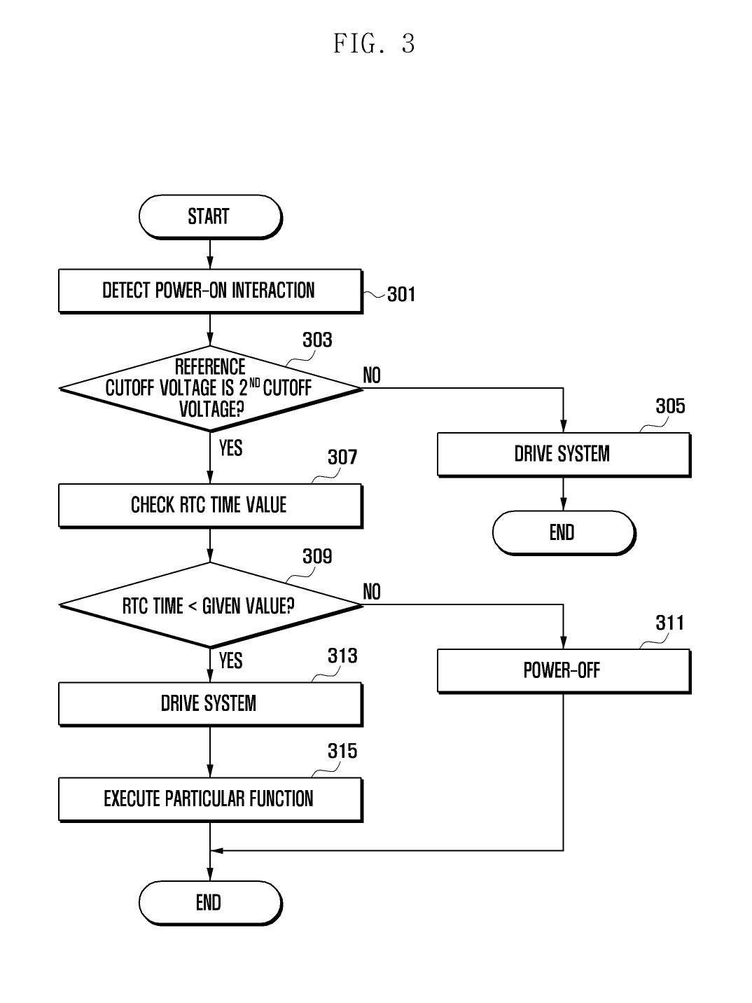

FIG. 3 is a flow diagram illustrating a power-on control process of a mobile device that has entered into the power-off state in a cutoff mode in accordance with another exemplary embodiment of the present invention.

Referring now to FIG. 3, at step (301) the control unit 160 may detect a power-on interaction of the mobile device. For instance, when a user presses a power button, the control unit 160 may detect a power-on interaction.

Next, at step (303) the control unit 160 determines whether a reference cutoff voltage is the second cutoff voltage. Namely, the control unit 160 may determine whether a reference cutoff voltage is set to be the second cutoff voltage or the first cutoff voltage.

If a reference cutoff voltage is the first cutoff voltage, at step (305) the control unit 160 may control a system driving process based on a normal procedure. Specifically, in case where a reference cutoff voltage is the first cutoff voltage, the control unit 160 may measure the voltage of the battery 140 and then compare the measured battery voltage with the first cutoff voltage. If the battery voltage exceeds the first cutoff voltage, the control unit 160 may supply power to the above-discussed elements and then perform a loading of all functions required for a system booting. Although not illustrated in FIG. 3, the control unit 160 may keep a power-off state when the battery voltage does not exceed the first cutoff voltage.

If a reference cutoff voltage is the second cutoff voltage, at (step 307) the control unit 160 checks the value of RTC time. Then the control unit 160 (at step 309) determines whether an RTC time value is smaller than a predefined critical time value. Namely, by comparing the RTC time value with the predefined critical time value, the control unit 160 may determine whether the power-on interaction is made within a given time. If the RTC time value is equal to or greater than the critical time value, the control unit 160 may determine that the power-on interaction is made after the given time. If the RTC time value is smaller than the critical time value, the control unit 160 may determine that the power-on interaction is made within the given time.

If the RTC time value is equal to or greater than the critical time value, at (step 311) the control unit 160 controls a power-off process. Namely, if the RTC time is not smaller than the critical time value during a system driving process based on a power-on interaction, the control unit 160 may stop the system driving process and force the mobile device to be in a power-off state.

If the RTC time value is less than the critical time value, at step (313) the control unit 160 controls a system driving process according to an emergency mode. Specifically, the control unit 160 may supply power to minimal elements and control a system booting process based on minimal functions required for a system driving by a power-on interaction.

Next, at (step 315) the control unit 160 controls the execution of a particular function prearranged after a system driving according to an emergency mode. For instance, the control unit 160 may control a function in connection with an emergency call service.

Meanwhile, the above-discussed steps 307 and 309 may be performed corresponding to the step of driving the RTC timer in FIG. 2. Therefore, if this step of driving the RTC timer is omitted as discussed above, the control unit 160 may check the voltage of the battery 140 and then compare the battery voltage with the second cutoff voltage in the steps 307 and 309.

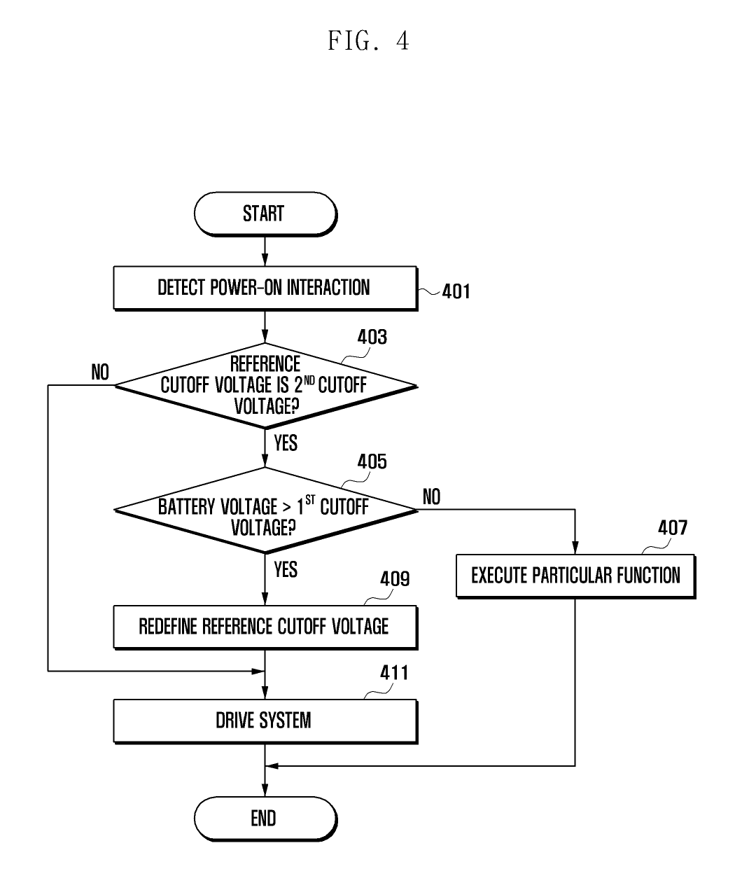

FIG. 4 is a flow diagram illustrating a power-on control process of a mobile device that has entered into the power-off state in a cutoff mode in accordance with still another exemplary embodiment of the present invention. Particularly, FIG. 4 shows case where the battery 140 is changed in the power-off state based on a cutoff mode.

Referring now to FIG. 4, the control unit 160 may detect a power-on interaction of the mobile device (step 401). For instance, when a user presses a power button, the control unit 160 may detect a power-on interaction.

Next, the control unit 160 determines whether a reference cutoff voltage is the second cutoff voltage (step 403). Namely, the control unit 160 may determine whether a reference cutoff voltage is set to be the second cutoff voltage or the first cutoff voltage.

If a reference cutoff voltage is the first cutoff voltage, the control unit 160 may control a system driving process based on a normal procedure (step 411). Specifically, in case where a reference cutoff voltage is the first cutoff voltage, the control unit 160 may measure the voltage of the battery 140 and then compare the measured battery voltage with the first cutoff voltage. If the battery voltage exceeds the first cutoff voltage, the control unit 160 may supply power to the respective elements of the mobile device and then perform a system booting process by loading all required functions.

If a reference cutoff voltage is the second cutoff voltage, the control unit 160 further determines whether the battery voltage is greater than the first cutoff voltage (step 405). Specifically, in case where a reference cutoff voltage is the second cutoff voltage, the control unit 160 may measure the voltage of the battery 140 and then compare the measured battery voltage with the first cutoff voltage.

If the battery voltage is equal to or less than the first cutoff voltage, the control unit 160 may control the execution of a particular function (step 407). For instance, if the battery voltage is not greater than the first cutoff voltage, the control unit 160 may perform the aforesaid steps from the step 307 in FIG. 3.

If the battery voltage is greater than the first cutoff voltage, the control unit 160 changes a reference cutoff voltage (step 409). Namely, if the battery voltage exceeds the first cutoff voltage due to a recharge or change of the battery 140, the control unit 160 may redefine the reference cutoff voltage by changing it from the second cutoff voltage to the first cutoff voltage.

Next, the control unit 160 may control a system driving process of the mobile device according to a normal procedure as discussed above (step 411).

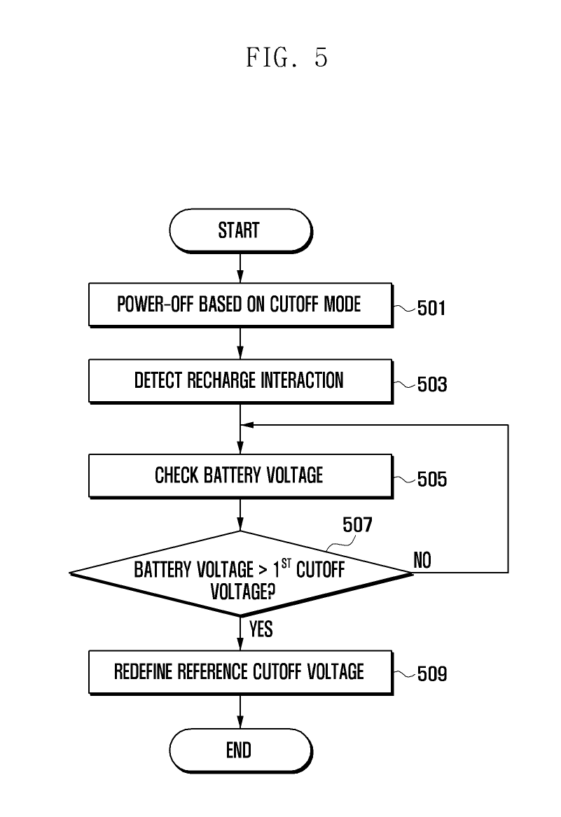

FIG. 5 is a flow diagram illustrating a battery recharge control process of a mobile device that has entered into the power-off state in a cutoff mode in accordance with yet another exemplary embodiment of the present invention.

Referring to FIG. 5, at (S501) the control unit 160 may force the mobile device to enter into the power-off state in a cutoff mode. For instance, when the voltage of the battery 140 is lowered under the reference cutoff voltage (e.g., the first cutoff voltage) due to a discharge of the battery 140, the control unit 160 may force the mobile device to enter into the power-off state according to a cutoff mode. Then, as discussed above, the control unit 160 may perform subsequent control steps such as redefining the reference cutoff voltage as the second cutoff voltage, driving the RTC timer, and the like.

Next, the control unit 160 may detect a recharge interaction for the battery 140 (step 503). For instance, the control unit 160 may detect the connection of an external adapter through an interface for a battery recharge and also detect the supply of power from the adapter through the interface.

When detecting a recharge interaction, (at step 505) the control unit 160 checks the voltage of the battery 140 and then determines (at step 507) whether the battery voltage is greater than the first cutoff voltage. For instance, the control unit 160 may periodically measure the battery voltage and compare the measured battery voltage with the first cutoff voltage.

If the battery voltage is not greater than the first cutoff voltage, the control unit 160 may return to the previous step 505 and repeatedly perform the above steps until the recharge interaction is removed.

If the battery voltage is greater than the first cutoff voltage, at step (509) the control unit 160 changes a reference cutoff voltage. Namely, the control unit 160 may redefine the reference cutoff voltage by changing it from the second cutoff voltage to the first cutoff voltage. Additionally, if the RTC timer is being driven, the control unit 160 may stop the drive of the RTC timer when redefining the reference cutoff voltage.

The above-described methods according to the present invention can be implemented in hardware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

In a method for a cutoff-based power control, a control unit of the mobile device detects a power-off interaction and, if the power-off interaction is based on the cutoff mode, redefines the reference cutoff voltage. The control unit forces the mobile device to enter into the power-off state and controls a system driving on the basis of the redefined reference cutoff voltage in the power-off state based on the cutoff mode.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for a cutoff-based power control in a mobile device, the method comprising:
detecting by a control unit a power-off interaction of the mobile device;
if the power-off interaction is based on a cutoff mode, redefining a reference cutoff voltage;
forcing the mobile device to enter into a power-off state; and
controlling a system driving of the mobile device on the basis of the redefined reference cutoff voltage in the power-off state based on the cutoff mode.

2. The method of claim 1, wherein the detecting of the power-off interaction includes:
determining whether the detected power-off interaction is based on a user's request to power-off the mobile device or by the cutoff mode in which a battery voltage is less than the reference cutoff voltage.

3. The method of claim 2, wherein the redefining of the reference cutoff voltage includes:
changing the reference cutoff voltage from a first cutoff voltage to a second cutoff voltage having a value that is less than a value of the first cutoff voltage.

4. The method of claim 3, wherein the first cutoff voltage is an initial cutoff voltage providing a first threshold to force the mobile device to enter into the power-off state in the cutoff mode, and wherein the second cutoff voltage is a cutoff voltage redefined as the reference cutoff voltage to provide a second threshold when the mobile device enters into the power-off state in the cutoff mode by means of the first cutoff voltage.

5. The method of claim 3, wherein the redefining of the reference cutoff voltage further includes:
driving a real time clock (RTC) timer when changing the reference cutoff voltage.

6. The method of claim 5, wherein the controlling of the system driving includes:
detecting a power-on interaction of the mobile device;
checking the reference cutoff voltage to determine whether the reference cutoff voltage is the first cutoff voltage or the second cutoff voltage;
if the reference cutoff voltage is the second cutoff voltage, checking an RTC time value;
if the RTC time value is equal to or greater than a predefined critical time value, forcing the mobile device to enter into the power-off state; and
if the RTC time value is less than the predefined critical time value, driving a system of the mobile device on the basis of the second cutoff voltage.

7. The method of claim 6, wherein the controlling of the system driving further includes:
if the reference cutoff voltage is the second cutoff voltage, comparing the battery voltage with the first cutoff voltage; and
if the battery voltage is greater than the first cutoff voltage, redefining the reference cutoff voltage from the second cutoff voltage to the first cutoff voltage.

8. The method of claim 7, wherein the controlling of the system driving further includes:
if the battery voltage is not greater than the first cutoff voltage, checking the RTC time value.

9. The method of claim 6, wherein the controlling of the system driving further includes:
performing a system booting process based on a supply of power to a minimum of elements and the loading of minimum functions required for the system booting process performed by the minimum of elements.

10. The method of claim 3, further comprising:
detecting a battery recharge interaction in the power-off state based on the cutoff mode;
comparing the battery voltage with the first cutoff voltage; and
if the battery voltage is greater than the first cutoff voltage, redefining the reference cutoff voltage from the second cutoff voltage to the first cutoff voltage.

11. A mobile device comprising:
a power supply configured to receive and supply power;
a memory unit configured to store a reference cutoff voltage providing an entry into a power-off state based on a cutoff mode; and
a control unit configured to redefine the reference cutoff voltage when the mobile device enters into the power-off state based on the cutoff mode, and to control a system driving of the mobile device on the basis of the redefined reference cutoff voltage.

12. The mobile device of claim 11, wherein the memory unit is further configured to store a first cutoff voltage and a second cutoff voltage, wherein the first cutoff voltage comprises an initial cutoff voltage used for forcing the mobile device to enter into the power-off state in the cutoff mode, and wherein the second cutoff voltage comprises a cutoff voltage redefined as the reference cutoff voltage when the mobile device enters into the power-off state in the cutoff mode by means of the first cutoff voltage.

13. The mobile device of claim 12, wherein the second cutoff voltage is defined as a specific voltage value allowing the system driving with a minimum booting scenario to operate the mobile device in an emergency mode when a remaining capacity of power received by a power supply is reduced under the first cutoff voltage in the power-off state based on the cutoff mode.

14. The mobile device of claim 13, wherein the second cutoff voltage is less than the first cutoff voltage.

15. The mobile device of claim 12, wherein the control unit is further configured to change the reference cutoff voltage from the first cutoff voltage to the second cutoff voltage when redefining the reference cutoff voltage, and to determine whether to perform the system driving on a basis of the second cutoff voltage when detecting a power-on interaction within a given time.

16. The mobile device of claim 15, wherein the control unit is further configured to control a system booting process based on an emergency mode when performing the system driving on the basis of the second cutoff voltage, and to change the reference cutoff voltage from the second cutoff voltage to the first cutoff voltage when a recharge or change of power received by a power supply is made in the power-off state based on the cutoff mode.
